(19) United States
(12) Patent Application Publication
(10) Pub. No.: US 2019/0266544 A1
(43) Pub. Date: Aug. 29, 2019

(54) TECHNIQUES FOR MANAGING PROCESS-FLOWS ACROSS AN ENTERPRISE

(71) Applicant: ServiceNow, Inc., Santa Clara, CA (US)

(72) Inventor: Nireesha Mandala, Santa Clara, CA (US)

(21) Appl. No.: 15/906,562

(22) Filed: Feb. 27, 2018

(51) Int. Cl. G06Q 10/06; G06F 21/10; G06Q 10/10; H04L 29/08; H04L 12/24

(52) U.S. Cl. CPC G06Q 10/063112; G06F 21/105; G06Q 10/063114; G06F 3/0484; H04L 67/306; H04L 41/12; G06Q 10/1053

(57) ABSTRACT

A system may include a database within a remote network management platform that manages a managed network. The system may also include one or more server devices, disposed within the remote network management platform to provide a representation of a graphical user interface that displays a respective software application of the plurality of software applications. The respective software application may maintain profiles associated with users, where each of the profiles includes one or more skills based on interactions of the users with an enterprise. The respective software application may determine a skill associated with performing a function of the enterprise. The respective software application may search the respective software application to identify a respective profile that includes the skill from a plurality of profiles. Upon identification of the respective profile, the respective software application may assign a process-flow to the respective profile associated with the function of the enterprise.

### TECHNICAL FIELD

The present disclosure generally relates to techniques for association and management of a process-flow through coordinating activities of one or more members of an enterprise. More specifically, the present disclosure is related to techniques for coordinating activities of the one or members of an enterprise when the activities are related to, for example, member lifecycles at the enterprise.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In an enterprise, different operations related to managing a lifecycle of an individual may be performed by different departments (e.g., human resources, information technology) of the enterprise. For example, when a hiring event within the enterprise begins, different departments may perform activities (e.g., departmental functions) to prepare for hiring the new employee or to hire the new employee. In some instances, one department may become aware of the performed activity via notification from another department. Otherwise, each different department may independently initiate an activity for fulfillers to perform without regard to the activities being performed by other departments. In view of the myriad departments and individuals that may have actions to be performed as part of a lifecycle event, it is difficult to coordinate performance of these actions and to ensure all actions in a timely and ordered manner.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below

In a first embodiment, a system may include a database within a remote network management platform that manages a managed network. The database may include licensing information that includes respective indications of license rights allocations and consumption for each of a plurality of software applications associated with the managed network. The system may include one or more server devices, within the remote network management platform, that provide, to a client device associated with the managed network, a representation of a graphical user interface that displays a respective software application of the plurality of software applications, wherein the respective software application is associated with an enterprise. The respective software application may maintain profiles associated with users, where each of the profiles may include one or more skills based on interactions of the users with an enterprise. The respective software application may also determine a skill associated with performing a function of the enterprise. The respective software application may also search the respective software application to identify a respective profile that includes the skill from a plurality of profiles. Upon identification of the respective profile, the respective software application may also assign a process-flow to the respective profile associated with the function of the enterprise.

In a second embodiment, a system may include a database within a remote network management platform that manages a managed network. The database may include licensing information that includes respective indications of license rights allocations and consumption for each of a plurality of software applications associated with the managed network. The system may also include one or more server devices, within the remote network management platform, configured to provide, to a client device of a respective enterprise of a plurality of enterprises associated with the managed network, a representation of a graphical user interface that displays a respective software application for the respective enterprise of the plurality of software applications. The respective software application may maintain a function, wherein the function may be associated with a departmental task of the respective enterprise. The respective software application may maintain a profile of a user, wherein the profile of the user includes one or more skills based on interactions of the user with the plurality of enterprises. The respective software application may also determine a skill associated with the function. If the profile includes the skill associated with the function, the respective software may recommend to the respective enterprise that the profile of the user be associated with the function.

In a third embodiment, a method involves maintaining a function of an respective enterprise of a plurality of enterprises. The method may also involve maintaining a first profile, wherein the first profile includes a first indication based on an interaction of a first user associated with the first profile with the plurality of enterprises. The method may also involve determining a second indication associated with the function. The method may also involve determining if the second indication is the first indication, and if the second indication is the first indication, the method may involve associating the function with the first profile.

### BRIEF DESCRIPTION OF THE DRAWINGS

Various aspects of this disclosure may be better understood upon reading the following detailed description and upon reference to the drawings in which:

FIG. 1 is a block diagram of a system that utilizes a distributed computing framework, in accordance with aspects of the present approach;

FIG. 2 is a block diagram of example components of a computing device included in the distributed computing framework of FIG. 1, in accordance with aspects of the present approach;

FIG. 3 is a block diagram of an example server system of the distributed computing framework of FIG. 1, in accordance with aspects of the present approach;

FIG. 4 is a block diagram of an enterprise management architecture of the example server system of FIG. 3, in accordance with aspects of the present approach;

FIG. 5 is a flowchart of a method for coordinating a hiring process-flow that relies on members across an enterprise that utilizes the distributed computing framework of FIG. 1, in accordance with aspects of the present approach;

FIG. 6 is a hiring process-flow that the server system of FIG. 3 may assign to a profile of an applicant that created an application event in response to a job opening of the enterprise, in accordance with aspects of the present approach;

FIG. 7 is an illustration of a hiring process-flow overview page that depicts the hiring process-flow of FIG. 6, in accordance with aspects of the present approach; and

FIG. 8 is an illustration of a screen that displays results from data analytics associated with the hiring process-flow of FIG. 6 and one or more profiles of one or more applicants, in accordance with aspects of the present approach.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Information Technology (IT) devices are increasingly important in industrial, government, corporate and private settings in which various electronic devices are interconnected within a distributed context. As more functions are performed by services using some form of distributed computing, the usefulness of IT devices to coordinate activities for different members across an enterprise increases. That is, different departments of an enterprise may be located in different places and may operate independent of each other but may still desire having department activities coordinated. Employing certain IT devices, such as a server system that is communicatively coupled to databases related to the different departments, may facilitate the different departments with communicating and/or coordinating with each other throughout process-flows of the enterprise.

For example, certain IT devices may help departments communicate and coordinate throughout a hiring process, i.e., an on-boarding process, in which the IT devices are used to progress through, or execute, a hiring process-flow and coordinate activities of the departments in the process. A hiring process-flow may be a task or activity flow developed to make a hiring decision on an applicant to a job posting of the enterprise and, if hired, to on-board the hired applicant as a new member. A particular hiring process-flow may include one or more steps, or hiring action items or tasks, to be performed by one or more fulfillers affiliated with one or more departments or by the IT device to complete the hiring decision or to complete the on-boarding of the new employee (e.g., fulfillers of respective enterprise departments perform tasks to make a hiring determination of an individual and to process a newly hired individual through an on-boarding procedure). Thus, if the hiring action items are completed and an end of the hiring process-flow is reached, the hiring process is completed and the applicant has either been rejected, waitlisted, or on-boarded. Throughout the completion of the hiring process, the process-flow may be associated by the IT device with a profile of the applicant (e.g., record of biographical data of the applicant, record of past job applications from the applicant) and stored for further reference and/or analysis. Additionally, the enterprise may decide to associate skills of the member to the profile thus creating a representation of a start-to-end view of a member timeline, experiences, or lifecycle, at the enterprise.

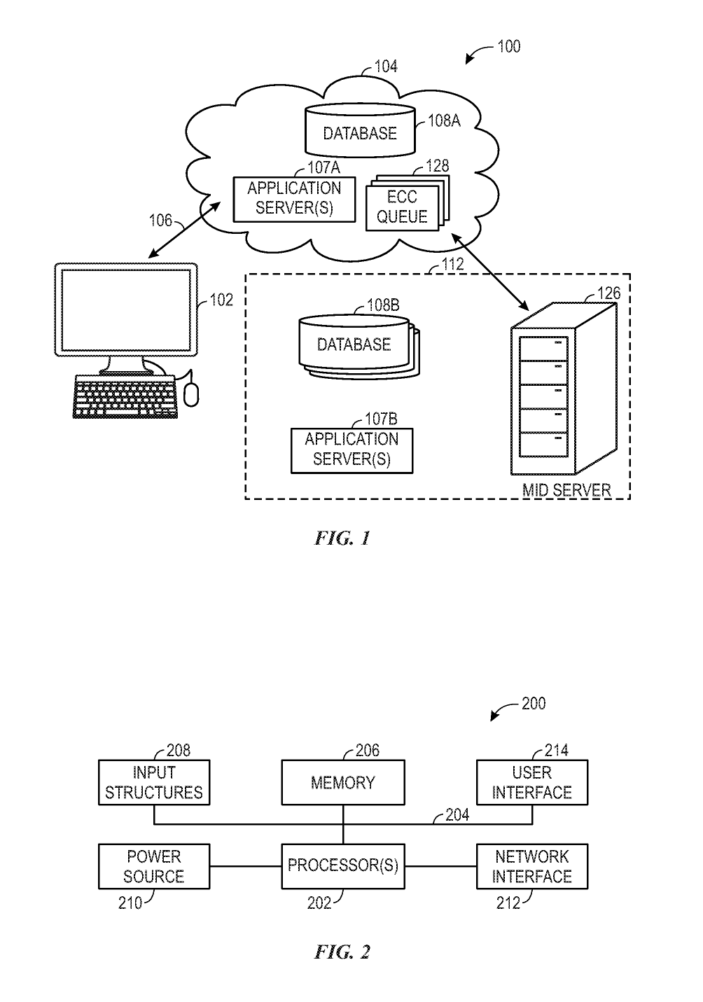

By way of introduction, FIG. 1 is a block diagram of a system 100 that utilizes a distributed computing framework, which may perform one or more of the techniques described herein. As illustrated in FIG. 1, a client 102 (e.g., client device) communicates with a cloud service 104 over a communication channel 106. The client 102 may include any suitable computing system. For instance, the client 102 may include one or more computing devices, such as a mobile phone, a tablet computer, a laptop computer, a notebook computer, a desktop computer, or any other suitable computing device or combination of computing devices. The client 102 may include client application programs running on the computing devices. The client 102 may be implemented using a single physical unit or a combination of physical units (e.g., distributed computing) running one or more client application programs. Furthermore, in some embodiments, a single physical unit (e.g., server) may run multiple client application programs simultaneously.

The cloud service 104 may include any suitable number of computing devices (e.g., computers) in one or more locations that are connected together using one or more networks. For instance, the cloud service 104 may include various computers acting as servers in datacenters at one or more geographic locations where the computers communicate using network and/or internet connections. The cloud service 104 may also support a multi-instance architecture, as discussed in greater detail below, in which the clients 102 access differing instances (e.g., computational instances) that may be implemented as virtual machines instantiated at the same or different data centers. In such instances, different instances may provide access to application nodes and/or databases specific to a given enterprise or entity or that may be shared by different enterprises or entities. Such application nodes and/or databases may be used in the implementation of the approach discussed herein.

The communication channel 106 may include any suitable communication mechanism for electronic communication between the client 102 and the cloud service 104. The communication channel 106 may incorporate local area networks (LANs), wide area networks (WANs), virtual private networks (VPNs), cellular networks (e.g., long term evolution networks), and/or other network types for transferring data between the client 102 and the cloud service 104. For example, the communication channel 106 may include an Internet connection when the client 102 is not on a local network common with the cloud service 104. Additionally or alternatively, the communication channel 106 may include network connection sections when the client and the cloud service 104 are on different networks or entirely using network connections when the client 102 and the cloud service 104 share a common network. Although a single client 102 is shown connected to the cloud service 104, it should be noted that cloud service 104 may connect to multiple clients 102 (e.g., tens, hundreds, or thousands of clients 102).

Through the cloud service 104, the client 102 may connect to various devices with various functionality, such as gateways, routers, load balancers, databases, application servers running application programs on one or more nodes, or other devices that may be accessed via the cloud service 104. For example, the client 102 may connect to an application server 107A and/or one or more databases 108A via the cloud service 104. The application server 107A may include any computing system, such as a desktop computer, laptop computer, server computer, and/or any other computing device capable of providing functionality from an application program to the client 102. For example, the application server 107A may store one or more pages (e.g., community pages, job posting listings, knowledge management pages, customer service management pages, centralized discussion board, centralized posting service, and so forth, as discussed herein) with which one or more of the users may interact (e.g., view, post, apply, etc.) with other users and/or members of the enterprise.

The application server 107A may include one or more application nodes running application programs whose functionality is provided to the client 102 via the cloud service 104. The application nodes may be implemented using processing threads, virtual machine instantiations, or other computing features of the application server 107A. Moreover, the application nodes may store, evaluate, or retrieve data from the databases 108A and/or a database server.

The databases 108A may contain a series of tables containing information about assets and services controlled by the client 102 and the configurations of these assets and services. The assets and services may include hardware resources (e.g., server computing servers, client computing devices, processors, memory, storage devices, networking devices, or power supplies), software resources (e.g., instructions executable by the hardware resources including application software or firmware), virtual resources (e.g., virtual machines, virtual storage devices), and/or storage constructs (e.g., data files, data directories, or storage models).

In some embodiments, the databases 108A, whether in the cloud or at a client site accessible via the cloud or other network interconnection, may include information related to activity sets for certain personnel to perform. The databases 108A may each be associated with one or more departments of an enterprise. That is, an enterprise or organization may include a number of different departments that perform different operations for the overall enterprise. For example, an IT department may assist in connecting IT devices, software or applications, or virtualized environments for a member (e.g., employee) of the enterprise, a human resources department may assist in hiring an applicant as a member, and a facilities department may assist in providing access to various building associated with a member.

In addition to the databases 108A, the cloud service 104 may include one or more other database servers. The database servers are configured to store, manage, or otherwise provide data for delivering services to the client 102 over the communication channel 106. The database server may include one or more additional databases that are accessible by the application server 107A, the client 102, and/or other devices external to the additional databases. By way of example, the additional databases may include information related to members or assets of the enterprise. In some embodiments, the information regarding each member may be organized or stored in a respective database of the databases 108A based on a department in which the member is assigned to. The information may include data regarding the member such as skill set, education background, role, job function, assigned activities or tasks, location, demographic information, and the like.

In the depicted topology, access to non-cloud resources, such as database 108B and/or application server 107B, from the cloud service 104 is enabled via a management, instrumentation, and discovery (MID) server 126 via a communication queue 128 (e.g., an External Communications Channel (ECC) queue). The MID server 126 may include an application program (e.g., Java application) that runs as a service (e.g., Windows service or UNIX daemon) that facilitates communication and movement of data between the cloud service 104 and external applications, data sources, and/or services. The MID server 126 may be executed using a computing device (e.g., server or computer) on the network 112 that communicates with the cloud service 104.

The communication queue 128 may be a database table that is typically queried, updated, and inserted into by other systems. In such an implementation, each record in the communication queue 128 is a message from an instance in the cloud service 104 to a system (e.g., MID server 126) external to the cloud service 104 that connects to the cloud service 104 or a specific instance running in the cloud service 104 or a message to the instance from the external system. The fields of a communication queue 128 record include various data about the external system or the message in the record.

Although the system 100 is described as having the application servers 107A, the databases 108A, the communication queue 128, the MID server 126, and the like, it should be noted that the embodiments disclosed herein are not limited to the components described as being part of the system 100. Indeed, the components depicted in FIG. 1 are merely provided as example components and the system 100 should not be limited to the components described herein. Instead, it should be noted that other types of server systems may communicate with the cloud service 104 in addition to the MID server 126.

Further, it should be noted that server systems described herein may communicate with each other via a number of suitable communication protocols, such as via wired communication networks, wireless communication networks, and the like. In the same manner, the client 102 may communicate with a number of server systems via a suitable communication network without interfacing its communication via the cloud service 104. In some embodiments, communication and/or sharing of data between one or more enterprises may be facilitated through communication protocols and/or through the cloud service 104. In these embodiments, a first enterprise may provide permissions associated with a second enterprise that limits the kind and/or amount of data shared with the second enterprise. For example, the first enterprise may decide that incident-related data may be shared with the second enterprise if the incident-related data is reclassified (e.g., reclassified as “community questions” or “resolving customer service requests). Permissions (e.g., licensing information, indications of license right allocations, directional trust levels, bi-directional trust levels) may be used to limit the access of confidential and/or privileged data between the one or more enterprises of the managed network.

In addition, methods for populating the databases 108A may include directly importing data or entries from an external source, manual import by users entering or updating data entries via a user interface, and the like. Moreover, it should be understood that the embodiments described herein should not be limited to being performed with respect to a particular database or type of stored data. Instead, the present systems and techniques described herein may be implemented with any suitable database.

As mentioned above, the system 100 support a multi-instance architecture in which the client(s) 102 may access one or more instances that may be implemented as virtual machines instantiated at the same or different data centers. Each virtual machine may include a load balancer, one or more application nodes to access the virtual machines, and a database. These virtual machines may be included in a network management platform, such as a remote network management platform. The database of a virtual machine may be read-write and/or read-only. As part of the network management platform, some databases of virtual machines may be replicated, or used in backing up data of the system 100. For example, databases of a virtual machine may be replicated via MySQL binlog replication for near real-time replication between a primary database and a secondary database. Application nodes associated with the virtual machine may access the databases of that virtual machine if the application node is associated with a primary database. Further, if the application node is associated with a secondary database, the application node may access the secondary databases as well as the primary database corresponding to the secondary database. Application nodes may further be associated with a software application, where respective enterprises may have respective application nodes and/or respective software applications.

In some embodiments, the client 102 may connect to a customer network designed to connect through an internet connection (e.g., via a managed network connection) to one or more virtual machines. Each customer (e.g., an enterprise) may have its own dedicated virtual machine, and some customers (e.g., some enterprises) may have one or more secondary virtual machines to perform replication of the primary dedicated virtual machine. Further, full and incremental backups may be scheduled as the customer wishes (e.g., daily, weekly, bi-weekly, monthly, etc.). The multi-instance architecture described herein causes full instance redundancy for production instances with near real time replication and no comingling of data between customers. By providing customers with individual, and separated, databases (e.g., in the dedicated virtual machines), customers are isolated from database maintenance and/or database issues of other customers. Further, maintenance and repair windows are shortened (e.g., as diagnostics and repairs may be more focused). In some embodiments, a client 102 may pull data from multiple different databases from multiple virtual machines and/or data centers. The pulled data may be combined and used as inputs to perform a task, such as dynamic scheduling of service appointments, enterprise job functions, or a tasks associated with a hiring process. The pulled data and/or the multi-instance architecture may facilitate in the virtual machine supporting a respective software application for the enterprise, where the respective software application may provide a graphical user interface (e.g., via a computing device associated with the enterprise, or client 102 device) to help perform and/or coordinate enterprise functions. For example, respective software application (e.g., an enterprise management program) may maintain profiles of individuals related to the enterprise, track skills of the individuals on the profiles, determine skills of the individuals based on tasks completed for the enterprise, share skills of the individuals with other enterprises, and/or may assign, or recommend assignment of, enterprise functions to individuals based on the tracked skills.

In any case, to perform one or more of the operations described herein, the client 102, the application server 107A, the MID server 126, and other server (e.g., service devices) or computing system described herein may include one or more of the computer components depicted in FIG. 2. FIG. 2 is a block diagram of example components of a computing device 200 and their potential interconnections or communication paths, such as along one or more busses. As briefly mentioned above, the computing device 200 may be an embodiment of the client 102, the application server 107A, a database server (e.g., databases 108A), other servers or processor-based hardware devices present in the cloud service 104 (e.g., server hosting the communication queue 128) or at a local or remote client site, a device running the MID server 126, and so forth. As previously noted, these devices may include a computing system that includes multiple computing devices and/or a single computing device, such as a mobile phone, a tablet computer, a laptop computer, a notebook computer, a desktop computer, a server computer, and/or other suitable computing devices.

As illustrated, the computing device 200 may include various hardware components. For example, the computing device 200 includes one or more processors 202, one or more busses 204, memory 206, input structures 208, a power source 210, a network interface 212, a user interface 214, and/or other computer components useful in performing the functions described herein.

The one or more processors 202 may include processors capable of performing instructions stored in the memory 206. For example, the one or more processors 202 may include microprocessors, system on a chips (SoCs), or any other performing functions by executing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206. Moreover, the functions of the one or more processors 202 may be distributed across multiple processors in a single physical device or in multiple processors in more than one physical device. The one or more processors 202 may also include specialized processors, such as a graphics-processing unit (GPU). A user interface 214 may include a display that displays, or presents, images transferred to it from the one or more processors 202.

The one or more busses 204 include suitable electrical channels to provide data and/or power between the various components of the computing device 200. For example, the one or more busses 204 may include a power bus from the power source 210 to the various components of the computing device 200. Additionally, in some embodiments, the one or more busses 204 may include a dedicated bus among the one or more processors 202 and/or the memory 206.

The memory 206 may include any tangible, non-transitory, and computer-readable storage media. For example, the memory 206 may include volatile memory, non-volatile memory, or any combination thereof. For instance, the memory 206 may include read-only memory (ROM), randomly accessible memory (RAM), disk drives, solid state drives, external flash memory, or any combination thereof. Although shown as a single block in FIG. 2, the memory 206 may be implemented using multiple physical units in one or more physical locations. The one or more processor 202 accesses data in the memory 206 via the one or more busses 204.

The input structures 208 provide structures to input data and/or commands to the one or more processor 202. For example, the input structures 208 include a positional input device, such as a mouse, touchpad, touchscreen, and/or the like. The input structures 208 may also include a manual input, such as a keyboard and the like. These input structures 208 may be used to input data and/or commands to the one or more processors 202 via the one or more busses 204. The input structures 208 may alternatively or additionally include other input devices.

The power source 210 may be any suitable source for power of the various components of the computing device 200. For example, the power source 210 may include line power and/or a battery source to provide power to the various components of the computing device 200 via the one or more busses 204.

The network interface 212 is also coupled to the one or more processors 202 via the one or more busses 204 and includes one or more transceivers capable of communicating with other devices over one or more networks (e.g., the communication channel 106). The network interface 212 may provide a wired network interface, such as Ethernet, or a wireless network interface, such an 802.11, Bluetooth, cellular (e.g., LTE), or other wireless connections. Moreover, the computing device 200 may communicate with other devices via the network interface 212 using one or more network protocols, such as Transmission Control Protocol/Internet Protocol (TCP/IP), power line communication (PLC), Wi-Fi, infrared, and/or other suitable protocols.

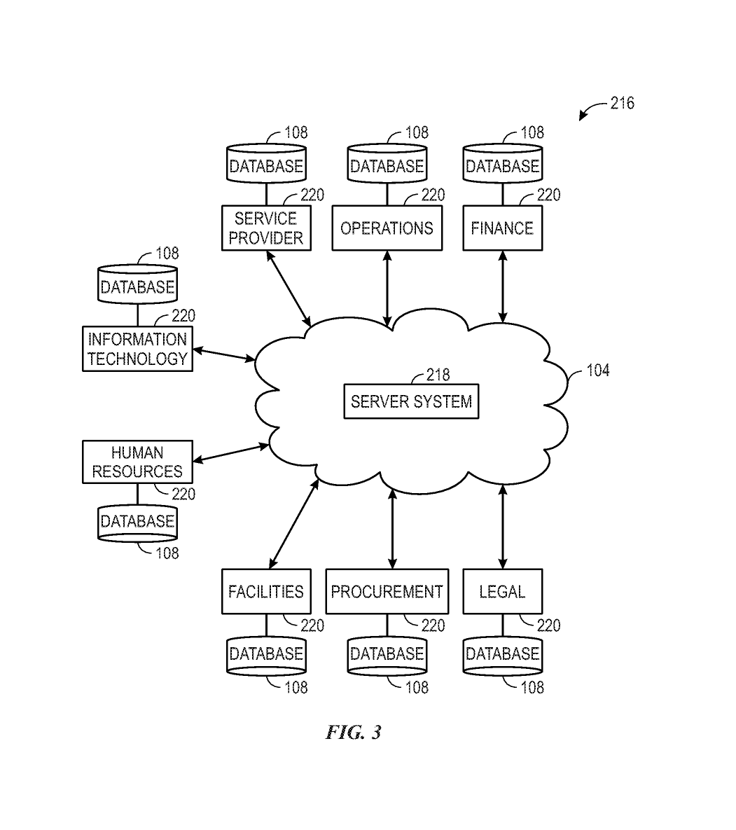

With the foregoing in mind, FIG. 3 is a block diagram of an example server system 216 (e.g., a server system of an enterprise) that may be communicatively coupled to different department server systems, such as via a multi-instance architecture implemented as part of a cloud service 104. As mentioned herein, a server system 218 may access a different of the database 108 associated with the different departments. As will be described below, the server system 218 may communicate with an enterprise management program and/or a data analytics program to facilitate coordination of departmental functions of the enterprise. Each database 108 associated with a respective department may communicate with the server system 218 via the cloud service 104 and a respective of department server systems 220 associated with the respective of the database 108. For example, FIG. 3 illustrates a number of the department server systems 220 that may respectively facilitate communication to, query requests, and the like, with the database 108.

By way of example, the department server systems 220 may be associated with departments such as an operations department, a finance department, a human resources (HR) department, an IT department, a service providers department, a legal department, a procurement department, and the like. Generally, a database 108 associated with each department may include data related to the members of the enterprise that are also part of the respective department, activities to be performed by the department, calendar information related to events scheduled for the respective department, and the like. In one embodiment, the data related to the members of the department may include a working schedule of the member, a list of skills of the member, a list of job functions performed by the member, and the like. The activities stored in the database 108 associated with a respective department may include a list of activities to be performed by a member of the respective department in response to a certain event and an association to a process-flow related to the event as discussed herein. For example, the list of activities to be performed may include hiring tasks or actions to be completed by a fulfiller of the respective department, where a specific combination of hiring tasks is determined in response to an application event and a membership status of an applicant to the enterprise. Furthermore, the event may be related to altering a status (e.g., employee on-boarding to a respective department, employee off-boarding from a respective department, employee location change, employee organization change, employee promotion, and the like) of a member of the enterprise.

Employee on-boarding may include instances when an applicant joins the enterprise and becomes a new member (e.g., employee) of the enterprise. Conversely, employee off-boarding may include when a member terminates his association with the enterprise. Employee location change may refer to when a member moves locations within the enterprise. The location change may include a change in office space with respect to one office building and/or with respect to a different geographical location (e.g., city, state, country). Employee organization change may include changing the department in which the member is associated with. In addition, employee promotion may include instances when a job title of a member changes, and/or when responsibilities or job functions of the member changes.

In FIG. 3, each of the illustrated departments may perform different functions that contribute to the operation of the enterprise as a whole and which may intersect or inter-relate for certain functions. For example, the finance department may be tasked with generating payroll, task, and benefit distributions for the enterprise. The legal department may be tasked with preparing, reviewing, and securing execution of employment agreements as well as handling legal issues related to personnel management. The procurement department may manage the acquisition and distribution of supplies, products, and services used by members of the enterprise. The facilities department may control access to buildings, offices, and other location related assets owned and operated by the enterprise. In addition, the human resources department may manage the employment services provided to a member of the enterprise. For example, the HR department may collect information regarding a new member, coordinate benefits services provided to the new member, and the like. The IT department may manage the devices (e.g., printer, databases 108, server systems 220, computing device 200) used by the new member for the enterprise. The service providers department may coordinate with vendors and other organization that provide services used by or managed by members of the enterprise. It should be noted that the foregoing list of departments should not be construed as an exclusive list of departments or a defined list of operations performed by the department; instead, the description of the departments are provided as examples, particularly in the context of the interrelatedness of functions provided by these departments in an employment context, and may include additional departments and additional operations and tasks for the described departments.

Given the number of different departments associated with a single enterprise, coordinating activities across the enterprise may prove challenging. For example, during an employee on-boarding process, a number of departments may have activities, or tasks, to perform to enable the new member to perform job functions more quickly and efficiently. Keeping this example in mind, as part of the employee on-boarding process, the IT department may identify a computing device 200 for the new member to use, add the new member to a database 108 for access to the server system 218 or other computing resources, issue a network user name for the new member, and the like. In the same manner, the HR department may prepare documents for the new member to review and sign upon starting his/her employment. The facilities department may assign a workspace to the new member and may prepare a badge or other identification material for the new member to gain access to certain buildings based on the department that the new member will be joining, the job functions of the new member, and the like.

As shown in the example above, different departments may have different activities that are to be performed based on a given event associated with a member of the enterprise. To make matters more complex, the different departments may perform certain activities in response to a different activity performed by another department. The activities described may be based on the type of event and the member involved in the event. In some embodiments, non-members of the enterprise may additionally or alternatively be involved in the event. Specific events and specific types of members or non-members may have different activities that occur before the process-flow is completed. Coordinating the different departments to execute the activities of the process-flow may be improved through the server system 218 managing assigning and tracking statuses of the activities, such that the different departments report and maintain activity status via the server system 218. Activity coordination of the enterprise may be further improved by identifying and tracking skills of members and users associated with the enterprise (e.g., such that enterprise functions may be assigned to members of the enterprise based on skills, or quantifiable interactions of the member with the enterprise).

Take the hiring of an applicant to a job posting as an example. The departments may have different activities, or hiring tasks, that are to be performed to complete a process associated with an application event, and at least based on a profile of an applicant, and which may be collectively referred to as a hiring process-flow. Furthermore, the applicant may have skills identified through interaction of the applicant with the enterprise. Accessing data related to the skills of the applicant may further improve the hiring processes by helping to measure or quantify relevant aspects of a user, some of which may ordinarily be intangible or otherwise difficult to quantify. Skills are associated with profiles for users maintained by the enterprise. These profiles ultimately sync and store skills of the user, if the user is an applicant of the enterprise, a job application of the user, and, if the user is a member of the enterprise, an employment history of the member. A profile of a user becomes more complete over time as a number of interactions between the user and the enterprise increases over time, or as the enterprise associates more information of the user with the profile. In sum, this improvement to the hiring process creates a start-to-end hiring process-flow of an applicant as well as a start-to-end view of the applicant being a member of the enterprise.

As briefly described, a profile is created by the server system 218 when a user performs a first interaction with the enterprise. For example, a first interaction may include submitting a job application through a job posting maintained by the enterprise, creating an account to contribute to a centralized discussion board maintained by the enterprise, and so forth. Interactions between the user and the enterprise may cause points to be recorded for the user. As interactions of the various users occur (e.g., posting content, interacting with content, answering questions, responding to service requests, resolving issues, etc.) with the enterprise (e.g., through an enterprise-sponsored centralized discussion board), the interactions are associated with skills that may be deemed of interest to the enterprise or are otherwise tracked by the enterprise. Users are awarded points that correspond to the respective skills. If a user is awarded points for a skill previously not associated with the user's profile, the points create indication of the skill and are associated profile. If the user is awarded points for a skill associated with the user's profile, the awarded points increment a total number of points for the skill.

This helps to gamify user interactions with the enterprise. For example, more points may be awarded to a user who answered a harder question and may incentivize users to answer harder questions. Quantifying a difficultly level of a question may help the enterprise in quantifying user interactions related to a particular technical classification that is more important to departmental function of the enterprise or are more difficult to interact with. In some embodiments, badges or levels (e.g., some form of quantitative, qualitative, or quantifiable indicator of expertise) associated with a given skill may be earned by accruing points. A user's level(s), badges, or points totals (e.g., point count) in each skill category (e.g., bucket) may be indicative of the skills possessed by the user and/or their areas of expertise and may be communicated to other users for use in evaluating or assigning an enterprise member to a task (e.g., enterprise function, enterprise-related task).

Indications of the skills (e.g., user's level(s), badges, or points) belonging to the user may be stored with the profile for the user. The profile associated with a user may also include data related to a current employment status of the applicant, a location of the applicant, one or more employment histories of the applicant, biographical information of the applicant, a social media account that includes information on a professional contacts (e.g., friends, co-workers, or other people the applicant knows and associates with through the social media account) of the applicant, a hiring process-flow of the user, and the like. An enterprise may gather and store indications of a variety of data related to the user and their relationship with the enterprise.

Thus, to improve the hiring process, the server system 218 may coordinate the accessing of the profile throughout the hiring process. Succinctly, when a user applies to a job posting (e.g., now considered an applicant), this application creates an application event that causes a hiring process-flow to be assigned to the applicant's profile, where the profile of the applicant (e.g., the profile of the user who applied) may be referenced during the hiring process to make decisions (e.g., determine if the user has demonstrated a skill related to the job posting). If the applicant is hired, the applicant is considered a member of the enterprise, and while as a member of the enterprise, the skills of the member may be determined and associated with the profile of the member over time. Thus, at the end of an employment of the member, the enterprise may have a start-to-end (e.g., from hiring to leaving) representation of a user.

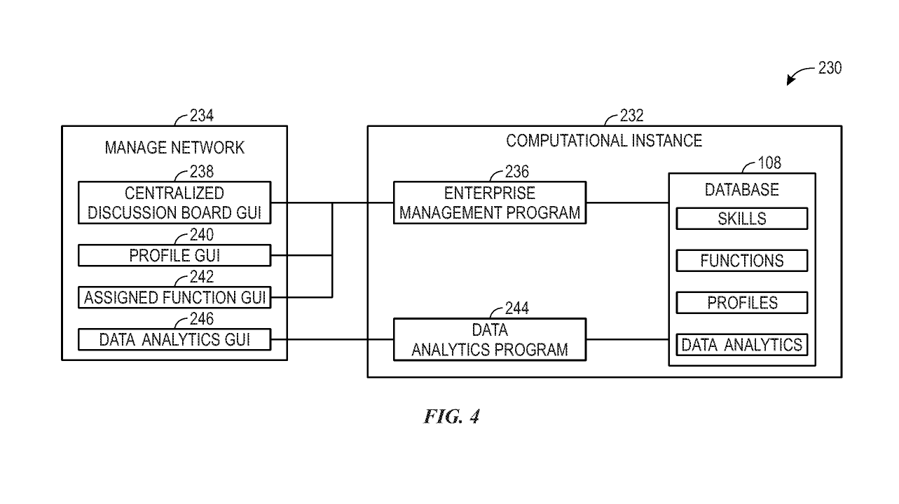

FIG. 4 is a block diagram of an enterprise management architecture 230 stored on one or more of the computing device 200, or associated with the server system 218, to manage functions of the enterprise, as described above. The enterprise management architecture 230 of a remote network may include a computational instance 232 and a managed network 234. Web portals, services, and/or applications may be accessed by the users associated with the enterprise through interaction with the computational instance. The computational instance 232 may remotely manage the managed network 234 to coordinate departmental functions of the enterprise, to coordinate users of the enterprise with departmental functions of the enterprise, and/or to coordinate users with other users to perform departmental functions of the enterprise. In some embodiments, one or more additional of the computational instance 232 may enable the enterprise computational instance 232 to interact with and/or share data with additional enterprises. These interactions (e.g., data updates for profiles shared between enterprises) may occur on pre-defined intervals, in response to user input, in response to triggers, and the like.

The computational instance 232 may include one or more software programs that receive and process data for the purposes of enterprise management and/or data analytics. These software programs may be standalone executable programs, scripts embedded into web pages, and the like. In some cases, the computational instance 232 may include an enterprise management program 236 to coordinate departmental functions of the enterprise. To coordinate the departmental functions, the enterprise management program 236 may communicate with the one or more databases 108 that include data indicative of one or more profiles (e.g., profiles of users associated with the enterprise), one or more skills (e.g., skills associated with user profiles), and one or more functions (e.g., departmental functions of the enterprise, job openings associated with a departmental function, tasks) of the enterprise. The one or more databases 108 may store data indicative of “profiles,” “skills,” “functions,” “data analytics,” and the like, in separate or the same databases, data stores, digital tables, and the like.

The enterprise management program 236 may maintain a centralized discussion board graphical user interface (GUI) 238, a profile GUI 240, and an assigned function GUI 242 to facilitate in user interaction with the enterprise. GUIs may be interactive, and may thus enable a user to modify information displayed, or interact with information displayed. Changes made to the GUIs by a user may be stored by the enterprise management program 236 into the one or more databases 108, such that the change is communicated to one or more additional users interacting with the GUI via the managed network 234. By communicating with the one or more databases 108, the enterprise management program 236 may transmit data from the one or more databases for presentation on the centralized discussion board GUI, the profile GUI, and/or an assigned function GUI.

The enterprise management program 236 may cause one or more visualizations related to a centralized discussion board of the enterprise to transmit to the centralized discussion board GUI 238, upon access of the centralized discussion board GUI 238 by a user. In response to the visualizations and/or data transmitted from the enterprise management program 236, upon accessing the centralized discussion board GUI 238, a user may interact (e.g., post questions, answer questions) with one or more additional users via the centralized discussion board.

User who interact with the enterprise via the computational instance 232, either through the centralized discussion board GUI 238 or as a member of the enterprise, may be assigned a profile. As described above, the enterprise management program 236 may store indications and/or data associated with a user profile in the one or more databases 108. A user interacting with the enterprise via the computational instance 232 may access a profile associated with the user via the profile GUI 240. The profile GUI 240 may indicate biographical data, a process-flow, to-do items associated with a departmental function of the enterprise, one or more skills associated with the user profile, and the like.

The enterprise management program 236 may assign departmental functions to one or more users associated with the enterprise. A user assigned a departmental function may access indications of the departmental function via the assigned function GUI 242. The assigned function GUI may include indications and/or data associated with one or more assigned departmental functions (e.g., process-flows, tasks) to a user via association with the profile of the user. The enterprise management program 236 may retrieve relevant data from the one or more databases (e.g., queries to “profiles” and “functions”) upon a request to generate an assigned function GUI by a user.

Finally, the enterprise management program 236 may communicate with a data analytics program 244 to perform and/or manage requests to view a data analytics GUI 246. The data analytics program 244 may access the one or more databases 108 to retrieve data indicative of departmental function completion (e.g., may be stored with “profiles,” indicating how long a task took for a user to complete), departmental functions (e.g., “functions), skills of users assigned to a particular departmental function (e.g., “skills” compared to “profiles”), a number of job openings added to the one or more databases 108 (e.g., “functions”), previous conclusions (e.g., “data analytics”), and the like. The data analytics program 244, either alone or in combination with the enterprise management program 236, may perform one or more data analytics routines on the retrieved data to arrive at a conclusion and/or prediction associated with completion departmental functions of the enterprise. For example, the data analytics program 244 may draw a conclusion regarding how suitable a particular skill is to completing a particular department function. For example, the data analytics program 244 may determine based on the retrieved data that a user having threshold of a “math” skill may be better suited to perform an accounting task. The data analytics routine may include the data analytics program 244 performing averaging functions, performance indicating functions, thresholding functions, index scoring functions, formulas building predictive indicators, and the like. The data analytics program 244 may update the data analytics GUI 246 with conclusions from executing the data analytics routine upon interaction from one or more users with the data analytics GUI 246.

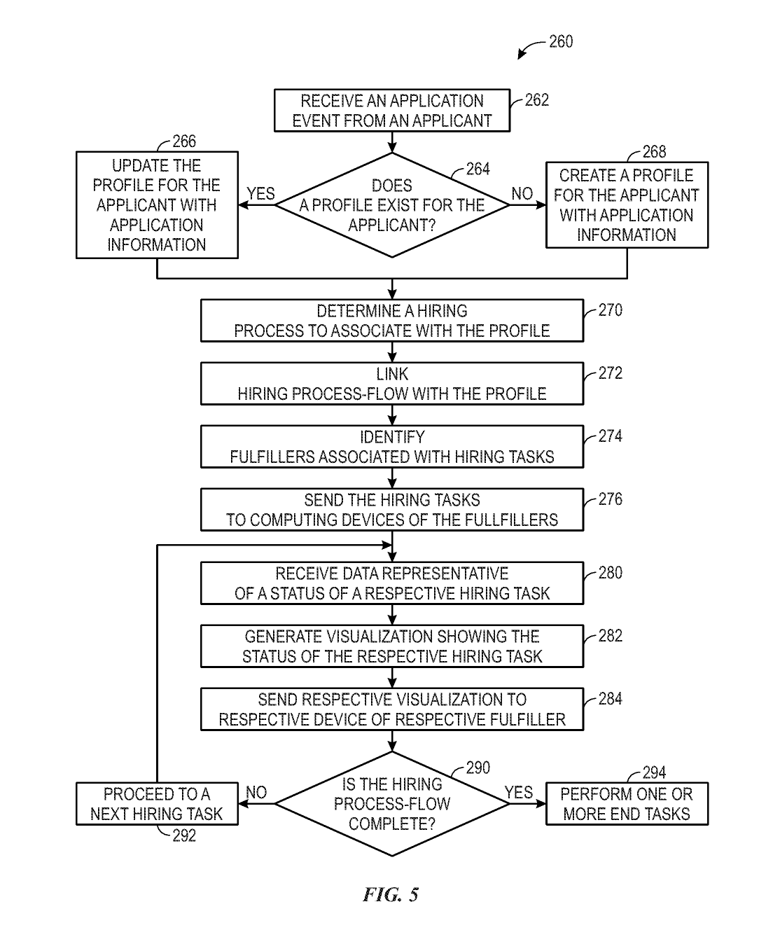

To describe the improvements made to the hiring process in more detail, FIG. 5 is a flow chart of a method 260 for coordinating a hiring process-flow between members across an enterprise based on an application event from an applicant. Although the following description of the method 260 is detailed in a particular order to facilitate explanation, it should be noted that the steps of the method 260 may be performed in any suitable order. Moreover, although the method 260 is described as being performed by a server system 218, it should be understood that the method 260 may be performed by any suitable computing device, or the enterprise management program 236, as described above. It should also be understood that method 260, while described in terms of a hiring process, may generally be applied to one or more sub-processes combined (e.g., through the server system 218 responding to triggers) into an aggregate hiring process-flow. Additionally it is understood that while method 260 is described in terms of hiring, a process-flow may be used in coordinating a variety of enterprise functions, such as purchasing, inventory management, IT incident response, and so forth.

Referring now to FIG. 5, at block 262, the server system 218 may receive an indication and/or may detect that an application event has occurred. The application event may refer to a submission of a job application by an applicant through an enterprise job opening portal. The enterprise job opening portal may be a centralized posting service that hosts one or more job openings for the enterprise. “Hosts” is understood to mean to offer a page to display (e.g., via the user interface 214) specific to a respective job opening such that an applicant may submit a job application to the respective job opening to initiate the application event (e.g., to cause the indication to transmit that the application event occurred) and begin a hiring process-flow.

The centralized posting service may provide to an applicant an option to search through the one or more job openings for a particular job opening based a location of the one or more job openings, a date of hosting of the one or more job openings, a department of the one or more job openings, and the like. The centralized posting service may additionally recommend job openings to a user. The recommendations may be based on a profile of the user (e.g., a profile created to store data gathered by the enterprise regarding the user) or other relevant information accessible by IT devices of the enterprise.

Once the applicant navigates and/or interacts with a job posting they are interested in applying for, the applicant may submit a job application through the centralized posting service to initiate an application event. The submission of the job application by the applicant may include data related to a current employment status of the applicant, a location of the applicant, one or more employment histories of the applicant, one or more skills, biographical information of the applicant, a social media account (e.g., LinkedIn) of the applicant that includes information on professional contacts (e.g., friends, co-workers, or other people the applicant knows and associates with through the social media account) of the applicant. Additionally or alternatively, upon a user indicating their interest in applying for a job posting (e.g., by selecting an “apply” button displayed on the centralized posting service), the user may be prompted to accelerate the application process by linking a social media account. Upon linking the social media account, a data scraper executed by the server system 218 may pull job histories, project histories, and/or biographical data from the social media account and auto-populate the information into data fields included in forms associated with the job application. The job application and data associated with the applicant may be linked, or saved, in a profile of the applicant at block 266 or 268, as will be described more herein. The job application and data associated with the profile of the applicant may be accessed by members of the enterprise associated with hiring to facilitate making a hiring decision.

Additionally or alternatively, triggers for causing the server system 218 to detect the application event may be pre-defined by a user of the server system 218. That is a user may provide an indication as to what constitutes an application event. In this way, a user may indicate to the server system 218 that when certain changes are applied to certain aspects to the centralized posting service or to other aspects of the server system 218, these changes correspond to an application event.

After detecting or receiving an indication of the application event, at block 264, the server system 218 may determine if a profile associated with the applicant is stored in one or more databases 108, or in a suitable location. A profile may exist in the one or more databases 108 if the applicant is a member of the enterprise, had previously applied to the enterprise, was previously a member of the enterprise but is not currently a member of the enterprise at the initiation of the application event, created a profile through the centralized posting service, created a profile through a centralized discussion board hosted by the enterprise (e.g., an digitally-accessible question/answer exchange forum that may be accessed via internet connections and is hosted and/or sponsored by the enterprise), and the like. A profile may not exist in the one or more databases 108 if the initiation of the application event is a first initiation and/or a first interaction with the enterprise for the applicant.

If the server system 218 determines that the applicant does have a profile, at block 266, the server system 218 updates the profile with the data from the submission of the job application by the applicant. In some embodiments, the server system 218 may save over, or delete, previously saved profile data of the applicant. In other embodiments, the server system 218 may update the profile of the applicant by saving the submission of the job application by the application in addition to previously saved profile data, such that when the update is complete, the profile includes any previous profile data in addition to the submission of the job application (e.g., differentiated through time stamps of the submission).

When the server system 218 updates the profile of the applicant, the server system 218 may update the profile with data from one or more machine-learning routines performed by the server system 218. For example, a machine-learning routine may determine that a particular pattern of activity indicates a particular skill. In some embodiments, the server system 218 may scan social media accounts associated with the applicant to determine if changes were made since a most recent updating of the profile. The changes may relate to people the applicant is connected to through the social media account (e.g., “friends” with, in the same professional network, and the like) or skills attributable to the applicant in the social media account. The enterprise may use the data from the social media account to determine how many members of the enterprise the applicant is connected to. Thus, the profile may be considered, at least in part, to be a history of the relationship between the enterprise and the applicant. The profile of the applicant provides a history of the data associated with the applicant and simplifies the access of the history by the computing device 200, and by the server system 218, through keeping the data accessible from a single location (e.g., the profile). As such, the enterprise may make future decisions based on data associated with a profile (e.g., to give a member, user, or applicant a promotion based on their hiring process-flow associated with the profile, to assign a particular task to a member based on their skill in a skill category, and so forth).

Keeping that in mind, if the server system 218 determines that the applicant does not have a profile digitally associated with them, at block 268, the server system 218 creates a profile for the applicant with the data from the submission of the job application by the applicant. The server system 218 may additionally or alternatively associate some or all of the data, or indications of information, gathered through the above-referenced data scraping process.

After updating or creating a profile for the applicant, at block 270, the server system 218 may determine a hiring process to associate with the profile of the applicant. Hiring process-flows may include one or more hiring tasks to be performed by one or more members of an enterprise to hire a new member (e.g., activities associated with the evaluation of an applicant until a completion of employee on-boarding). As such, the hiring process-flow may be a container object that includes information related to one or more hiring process-flow items to be performed for a particular hierarchical operation of the hiring process. For example, a hiring process may include an interview item, a background check item, a drug screening item, a completing 1-9 form item, a selecting equipment item, a setup office item, a setting up payroll item, and so forth. As exemplified, the hiring process-flow is a procedure of the enterprise related to an interviewing process and an on-boarding process for the applicant that includes one or more hiring tasks to be completed that define the procedure. As such, when the hiring process-flow tasks are complete, the hiring process-flow is complete.

The server system 218 may determine a hiring process-flow based on the application event and/or the profile of the applicant. For example, the server system 218 may associate a hiring process-flow based on a membership history of an applicant (e.g., previously a member, currently a member, never a member) and the department the applicant applied to. In this way, an applicant that applied to a job opening for a position in an IT department may have a first type of hiring process associated to his/her profile, while the applicant applying to a job opening for a position in an HR department of the enterprise may have a second type of hiring process associated to his/her profile. As a second example, an applicant that is a member of the enterprise (e.g., indicated via a profile of the applicant) applying for a position in an HR department of the enterprise may have a first hiring process, while a second applicant that is not a member of the enterprise applying for the position in the HR department may have a second hiring process. Finally, as a third example, a first applicant applying to a job opening in an HR department of the enterprise and a second applicant applying to the job opening in the HR department may both have a same type of hiring process associated to his/her respective profile, if both the first applicant and the second applicant are either both members of the enterprise or are both not members of the enterprise.

Additionally or alternatively, the server system 218 may determine a hiring process-flow based on triggers pre-defined by a user of the server system 218. That is, a user may provide an indication as to what constitutes a creation of and/or an association to a hiring process-flow. In this way, a user may indicate to the server system 218 that when certain changes occur and/or certain data is present, these changes and/or data correspond to a hiring process-flow to associate with an applicant.

It is noted that, as described earlier, a hiring process-flow may include one or more sub-processes that combine upon the server system 218 receiving a trigger. At block 270, the server system 218 may identify one or more possible sub-processes based on the triggers in preparation for executing the hiring process. For example, a hiring process may initially include an interviewing sub-process that, upon the server system 218 receiving a trigger associated with a hiring task (e.g., an applicant submitting an interview availability representative of times and dates of an interview compatible with their schedule), the server system 218 alters an existing hiring task (e.g., a fulfiller schedule is matched to the interview availability of the applicant) and/or the server system 218 associates an on-boarding sub-process (e.g., hiring tasks indicating to perform a background check, finalize details of offer letter, and/or mail offer letter) with the interviewing sub-process to on-board the new employee (e.g., occurs in the instance where a fulfiller's status update associated with the interviewing sub-process indicated that the applicant is hired), where the interviewing sub-process is combined with the on-boarding sub-process and included in the hiring process associated with a profile of an applicant.

After determining a hiring process for the applicant, at block 272, the server system 218 may link the hiring process-flow to the profile of the applicant. The server system 218 may link or associate in the one or more databases 108 the hiring process-flow to the profile of the applicant so that the hiring process may become a part of the applicant history saved through the profile. By associating the hiring process-flow with the profile, one or more additional application events initiated by the applicant may cause the server system 218 to reference the hiring process-flow in respective hiring processes of the one or more additional application events. Thus, a history of the profile is updated with the hiring process-flow such that members of an enterprise or the server system 218 may access the hiring process-flow if additional application events are initiated by the applicant.

After the hiring process-flow to be performed is identified, at block 274, the server system 218 may identify members of the enterprise associated with the hiring process-flow items as fulfillers of the hiring tasks (e.g., employees associated with the hiring process, employees to perform a hiring task, and so forth). The fulfillers may include one or more members of a department that may have job functions that include performing one or more of the hiring tasks included in the hiring process-flow. In addition, the fulfillers may include an applicant that the hiring process is directed towards. That is, the applicant, as a fulfiller, may be tasked with providing information to different fulfillers. For example, an applicant selected to be hired may be assigned a hiring task to provide his/her own preference for a computing device 200 as part of an on-boarding sub-process of the hiring process-flow and is considered by the server system 218 as a fulfiller for the hiring task for providing his/her own preference. In addition, it should be noted that the fulfiller may include any member of the enterprise. The information (e.g., name, location, schedule) of fulfillers assigned to one or more hiring tasks may be stored in the database 108 with respect to hiring process-flows via tables or the like.

In addition to identifying the fulfillers, in some embodiments, the server system 218 may determine trigger data associated with the hiring tasks of the hiring processes and prepare to perform response actions after receiving trigger data. That is, certain hiring tasks may be associated with date triggers, or alternative trigger data. For example, upon receiving an indication regarding when a new member will start employment, the server system 218 may identify or initiate an additional hiring process-flow associated with a starting date of the new member, identify one or more hiring tasks associated with the additional hiring process-flow, and/or determine one or more due dates for a subset of the one or more hiring tasks. For instance, the server system 218 may assign the IT department a hiring task for issuing a computing device 200 for the new member one week prior to a provided starting date. In response to receiving the provided starting date, one or more hiring tasks may be added to the hiring process or one or more pre-existing hiring tasks may be updated associated with the hiring process of the applicant being on-boarded as a new member.

In some embodiments, a user may specify trigger data for the server system 218. The trigger data may be specified with respect to the hiring task in metadata (e.g., data that describes other data) by the creator of the hiring task, or the like. However, in other embodiments, the server system 218 may identify common trends among assignment of a trigger, assignment of a department, and/or assignment of a hiring task, and the like, such that particular assignment patterns (e.g., trends) may be automatically applied when a member begins to design a hiring task for a new job opening. For example, if a particular member assigns a hiring task to a certain department more than two times, and the particular member specifies the same trigger data for the same hiring task each time, the server system 218 may automatically populate the trigger data for similarly created hiring task to include the same trigger data.

In some embodiments, the trigger data may be defined when a hiring task of a hiring process-flow is created by a user via a graphical user interface, input device, or the like. The trigger data may include a time input indicative of when a hiring task is initiated and/or completed. As mentioned above, each hiring task may have a set of criteria (e.g., human resources criteria) associated therewith that specifies to the server system 218 which hiring tasks of a hiring process are initiated, assigned, or completed. After identifying the hiring tasks that are to be performed, the server system 218 may identify a subset of the members of the enterprise to which the respective hiring tasks may be assigned. That is, the hiring task may be associated with some criteria that indicates that the hiring task may be assigned to members who work at a particular location, within a certain department, has a certain skill set, has a particular job title, and the like. These criteria may match information associated with a profile and/or stored in the database 108 of the member of the enterprise. In this way, the set of criteria associated with the respective hiring tasks may assist the server system 218 in identifying the appropriate members to perform the respective hiring tasks.

For example, a hiring task that corresponds to a new hire signing up for a 401K plan applies to members that are located in the United States and does not apply to members who are located outside of the United States, where the new hire is considered as a member. As such, the criteria for the 401K plan hiring task may include a location parameter indicating that the 401K hiring task is to be performed for United States located members only. With this in mind, it should be noted that the corresponding hiring process-flow may include hiring tasks for similar replacement benefits available in other countries but these hiring tasks may not be initiated due to the target member not having the appropriate criteria. In this way, certain hiring tasks of a respective hiring process-flow may apply to certain members and may not apply to all members. However, since the hiring process-flow may be programmed to include any suitable number of hiring tasks and the server system 218 may filter through the hiring tasks to associate applicable hiring tasks to a certain applicant to the profile of the certain applicant, the server system 218 is capable of personalizing a hiring process-flow for each applicant while maintaining coordination of activities between fulfillers and while retaining the flexibility to associate a number of different hiring process-flows for different members and different circumstances.

At block 276, the server system 218 may generate a list of assigned hiring tasks determined at block 274 for each of the fulfillers identified at block 274. In one embodiment, the server system 218 may store the assigned hiring tasks along with the associated fulfillers in a database 108 accessible to a number of the computing device 200 via a communication protocol. As such, the computing device 200 of a member may access the server system 218 or the database 108 that the server system 218 stores the hiring tasks and may retrieve information regarding the hiring tasks assigned to a respective fulfiller. In this way, the computing device 200 of the member may pull data from the database 108 or through the server system 218 in response to accessing the server system 218, from accessing a user interface associated with the member and the enterprise, or the like.

In some embodiments, the computing device 200 may access a user interface associated with the respective fulfiller via the cloud service 104 and may essentially send the hiring tasks to the respective fulfiller via updating an user interface (e.g., transmitting indications of a new visualization such that the user interface is updated with assigned hiring tasks). The server system 218 may generate a user interface that indicates a list of hiring tasks assigned to the respective fulfiller. In addition, the server system 218 may generate a visualization that lists the assigned hiring tasks, indicates a progress or status of the assigned hiring tasks, or the like. When the computing device 200 accesses the cloud service 104 or the server system 218, the computing device 200 may retrieve the list of hiring tasks, the generated visualizations or task data, and other pertinent information provided via the server system 218 and may display the retrieved information via a corresponding display device.

As the fulfiller completes hiring tasks, information regarding the completed hiring tasks may be updated via the user interface. The updated information may be received, at block 280, by the server system 218 as data representative of a hiring task status, or a status of the hiring task. In one embodiment, the fulfiller inputs update the status of the hiring process after each respective hiring task is completed. In another embodiment, the server system 218 may detect that a hiring task of the hiring process is completed when a certain data field or entry in the database 108 is updated. For instance, if the hiring task includes issuing a computing device 200 to a new member (e.g., a newly hired employee where the employee was an applicant but is now a new member post-hiring and post-on-boarding), when the fulfiller inputs data indicative of an assignment of a computing device 200 to the new member respectively into a database 108, the server system 218 may automatically update the respective status of the associated hiring task. The updated status may be received by the computing device 200 of the fulfiller via the server system 218. In some embodiments, the updated status may be received by the computing device 200 of members of the enterprise including the fulfiller via the server system 218 and in this way, a member may check or verify the status of a hiring task assigned to the fulfiller (e.g., a supervisor of the fulfiller may check to see if the fulfiller has completed the hiring task). Additionally or alternatively, the server system 218 may generate and transmit, a notification, announcement, reminder, and the like, upon status update and/or completion of the respective hiring task to notify associated fulfillers of the update in the process-flow.

At block 282, the server system 218 may generate one or more visualizations related to the status of the hiring tasks based on the data received at block 280. The visualizations may include information detailing a progress bar indicating steps completed, percentage completed, hiring tasks left, and the like. In one example, the visualizations may be provided to a respective user interface associated with the applicant who initiated the application event to provide an update as to a status of their application. In this example, a different visualization may be provided to the applicant that has not been approved for hiring when compared to the visualization provided to the applicant that has been approved for hiring (e.g., whether to include information on a respective department approval, the decision to include information about on-boarding specific hiring tasks like selecting a computing device).

In addition to the hiring tasks assigned to a particular fulfiller, the server system 218 may also generate visualizations indicative of statuses and data related to other hiring tasks associated with other fulfillers. The other fulfillers may include members of the enterprise that are supervised or managed by the particular fulfiller. As such, the particular fulfiller (e.g., a managing fulfiller) may track the progress of a number of hiring tasks associated with subordinate members classified as fulfillers of hiring tasks. With this in mind, certain visualizations may include tabs to access information related to hiring processes overseen by the particular fulfiller associated with the accessing computer device and for the subordinate members classified as fulfillers, information related to hiring processes for the subordinate members classified as fulfillers, information related to the hiring processes for the particular fulfiller, and the like.

Further, the server system 218 may provide organization features for the user interface to enable the particular fulfiller to view hiring tasks that are to be performed and hiring tasks that have been completed. The hiring tasks may also be organized with respect to due dates. The visualization may organize the hiring process with respect to time in a calendar, timeline, or the like.

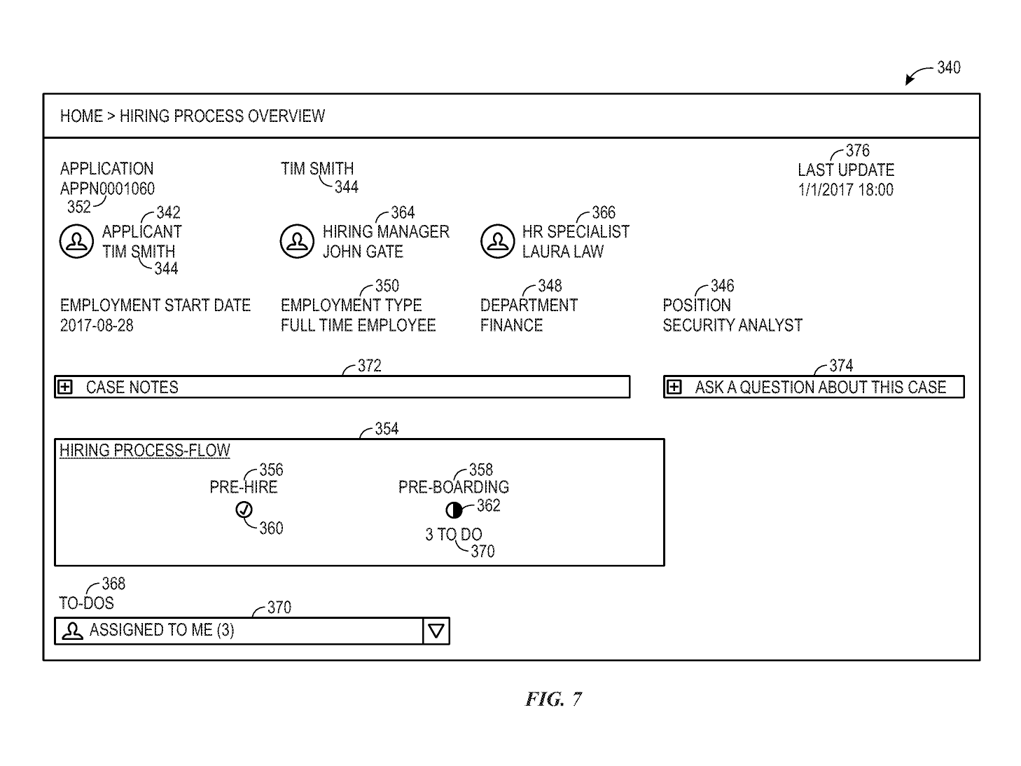

In some embodiments, the visualizations depicted in the user interface may be accessed by a configurable input coupled to a document (e.g., form, paperwork, contract) that the server system 218 may assign a fulfiller to complete and/or to interact with via the hiring task. The resulting document may be stored in the database 108 or the like, and the server system 218 may update a corresponding status of the hiring task, task associated with the document, or hiring process-flow accordingly. Additional detail about the user interface will be provided in the description accompanying FIG. 7.

After generating the visualizations, at block 284, the server system 218 may send the respective visualizations or respective user interfaces to a respective of the computing device 200. As such, each member of the enterprise may view assigned hiring tasks and selected members may provide updated statuses to the server system 218, which provides visibility to members across the enterprise. In some embodiments, the visualizations generated by the server system 218 for the applicant may be sent by the server system 218 to a computing device 200 of the applicant. In these embodiments, the applicant is able to track through the visualization a progress of the hiring process associated with the applicant event and the profile of the applicant. It is noted that in certain embodiments, different visualizations may be assigned to different hiring process-flows. For example, a visualization of a hiring process-flow for a first job opening may look different from a visualization of a hiring process-flow for a second job opening.

Once the respective visualizations and/or respective user interfaces are sent to the respective of the computing device 200, at block 290, the server system 218 may determine if the hiring process-flow is complete. The hiring process-flow may include an indication of an end to the hiring process. The end may be a logical block indicating the end to the hiring process-flow, such that when the server system 218 identifies the end to the hiring process-flow, the server system 218 may interpret the logical block as that the hiring process is complete. Additionally or alternatively, the end to the hiring process-flow may be indicated to the server system 218 through a trigger event and the like.

If the server system 218 determines that the hiring process-flow is not complete, at block 292, the server system 218 proceeds to a next hiring task. As described above, a hiring task may be assigned to a fulfiller of the enterprise. The hiring tasks may additionally or alternatively be tasks for the server system 218 to perform. In this way, the hiring process progresses as hiring tasks are indicated as complete through status updates. For a hiring task for the server system 218 to perform, a status of a hiring task may be updated automatically by the server system 218 and similarly to the status update previously described. In this way, a member of the enterprise may check on hiring tasks assigned to fulfillers and/or to the server system 218.

As previously described in the disclosure, a hiring task may be assigned a member (e.g., through digitally associating of a profile of the member to data of the hiring task), an applicant (e.g., through digitally associating of a profile of the applicant to data of the hiring task), and/or the server system 218 as the fulfiller. As such, the hiring tasks may include the following: creating and/or linking sub-processes to include in the hiring process-flow, prevent progression of the hiring process until a particular status update is received, permit progression of the hiring process when a particular status update is received, generate an email to send, trigger an email to send, generate a document for a fulfiller and/or an applicant to fill out, alter, and/or sign, generate a letter to mail, trigger a notification to a fulfiller to mail a letter, generate a phone call script and/or purpose of a phone call, trigger a notification to a fulfiller to initiate a phone call, automatically update a logical value stored in memory (e.g., memory 206) and/or in a field associated with a profile of the applicant, trigger a searching (e.g., neural network, machine-learning, artificial intelligence, key word search) routine to find data on one or more skills of an applicant through a centralized discussion board maintained by the enterprise, a member of the enterprise, and/or the server system 218, and the like.

When the server system 218 proceeds to a next hiring task, the server system 218 may update a visualization associated with the hiring process to indicate a progression through the hiring process-flow. Additionally or alternatively, the server system 218 may automatically transmit a notification indicating the next hiring task to the fulfiller of the next hiring task in response to a trigger (e.g., upon completion of a previous hiring task). The notification may be a message, a reminder, a calendar reminder, a window, and the like, generated and transmitted to a computing device 200 of the fulfiller. The notification may be a same notification for the next hiring task and/or the notification may be a customized notification for the next hiring task based on metadata associated with the next hiring task, an assigned fulfiller to the next hiring task, and the like. In this way, in proceeding to the next hiring task, the server system 218 may receive data representative of a status of the next hiring task, at block 280, and may generate a visualization showing the status of the next hiring task, at block 282.

If the server system 218 determines that the hiring process-flow is complete, at block 294, the server system 218 performs end tasks. When hiring process-flow is complete, an applicant may be considered hired and on-boarded or the applicant may be considered not hired. For example, in some embodiments, if the indication of the end occurs at the final step of hiring (e.g., the end of a complete hiring process-flow), the applicant may be considered hired and on-boarded while if the indication of the end occurs after one or more trigger data (e.g., one or more fulfillers indicate through a status update to not hire the employee, a bad impression after an interview causes a fulfiller to leave a bad rating of an applicant which is enough to cause a rejection of the applicant based on aggregate ratings from other fulfillers), the applicant may not be considered hired and on-boarded since the applicant is no longer in consideration by the enterprise for hiring. Generally, upon the server system 218 determining that the process-flow is complete, the method 260 completes and the process-flow may be considered completed.

Upon completion of a hiring process-flow, the server system 218 may generate and transmit a notification announcing the completion of the hiring process. The notification may be an email announcement, an update to one or more visualizations depicted in a user interface 214 associated with a fulfiller, an applicant, a new hire, a member, and the like. Additionally, the notification may be an alert, or a window, generated to be sent to a computing device 200 of a fulfiller, an applicant, a new hire, a member, and the like. In some embodiments, the completion of a hiring process may trigger a release of an announcement. In some embodiments, the completion of a hiring process may trigger the creation of one or more additional hiring process-flows or may trigger a status update for a hiring task in a separate hiring process-flow.

For example, if a hiring process-flow for an applicant to a manager position completes (e.g., the manager is hired), a hiring process-flow of a second applicant who applied to a subordinate position to the manager position may continue. In this example, the second applicant has a respective hiring task causing the hiring process of the second applicant to wait for the hiring of the manager position. Once the hiring of the manager position status is updated to indicate that the hiring is completed, the server system 218 may proceed to the next hiring task of the hiring process of the second applicant.

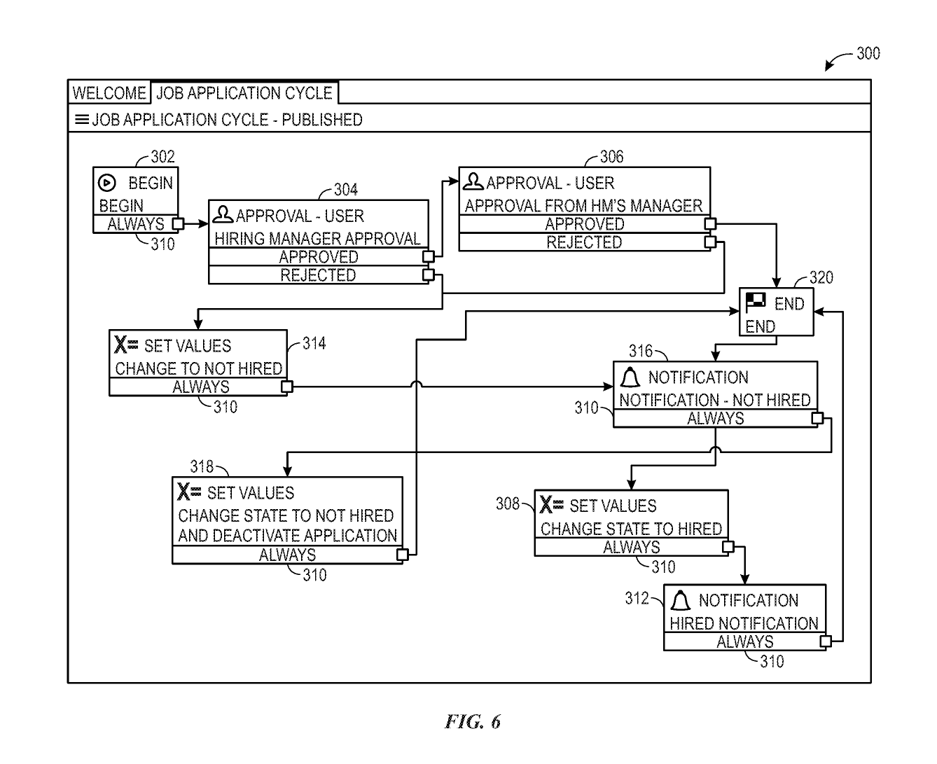

With the foregoing in mind, FIG. 6 is a hiring process-flow 300 that the server system 218 may assign to a profile of an applicant when determining the hiring process-flow to associate with the profile. Although the following description of the hiring process-flow 300 is described as being performed by the server system 218, it should be noted that any suitable computing device may perform the hiring process-flow 300.

Referring to FIG. 6, the process initiates at beginning block 302, from which the server system 218 proceeds to block 304 where the server system 218 waits for a first status update of a “Hiring Manager Approval” hiring task. The first status update provides indication of if a fulfiller for the “Hiring Manager Approval” hiring task approved or rejected the applicant.

If the status update provides an indication that the fulfiller for the “Hiring Manager Approval” hiring task approved the applicant, the server system 218 may proceed to block 306. At the block 306, the server system 218 may wait for a second status update of an “Approval from Hiring Manager's Manager” hiring task. The second status update provides indication of if a fulfiller for the “Approval from Hiring Manager's Manager” hiring task approved or rejected the applicant.

If the status update provides indication that the fulfiller for the “Approval from Hiring Manager's Manager” hiring task approved the applicant, the server system 218 may proceed to block 308. At the block 308, the server system 218, or a suitable computing device, is a fulfiller for a “Change State to Hired” hiring process-flow task. The server system 218 does not wait for a status update before progressing to a next hiring task, indicated by instruction 310 to “always” proceed to the next hiring task. The server system 218 may perform the “Change State to Hired” hiring task as the fulfiller for the “Change State to Hired” hiring task. As such, when the state in a profile of the applicant is changed to hired, the server system 218 may proceed to a “Hired Notification” hiring task at block 312. At the block 312, the server system 218, or a suitable computing device, is a fulfiller for the “Hired Notification” hiring task. Since the server system 218 is the fulfiller for the “Hired Notification” hiring task, the server system 218 may perform the “Hired Notification” hiring task. Thus, the server system 218 may transmit a notification indicative of the applicant being hired. The server system 218 may interpret metadata of the “Hired Notification” hiring task to determine one or more members to receive the notification, in addition to if the applicant receives the notification or a different notification of being hired.

However, if either the fulfiller for the “Hiring Manager Approval” hiring task or the fulfiller for the “Approval from Hiring Manger's Manager” provided a status update indicating that the applicant is rejected, the server system 218 proceeds to block 314. At the block 314, the server system 218 is a fulfiller for a “Change to Not Hired” hiring task. The server system 218 may perform the “Change to Not Hired” hiring task. Thus, the server system 218 may change metadata associated with the profile of the applicant to reflect that the applicant is not being hired. When the state is changed, the server system 218 continues to block 316. At the block 316, the server system 218 is a fulfiller for a “Notification—Not Hired” hiring task. The server system 218 may perform the “Notification—Not Hired” hiring task by transmitting a notification indicative of the applicant not being hired. The server system 218 may interpret metadata of the “Notification—Not Hired” hiring task to determine one or more members to receive the notification, in addition to if the applicant receives the notification or a different notification of not being hired.

Once the server system 218 transmits the notification at the block 316, the server system 218 proceeds to block 318. At the block 318, the server system 218 is a fulfiller for a “Change state to not hired and deactivate application” hiring task. As the fulfiller, the server system 218 may perform the “Change state to not hired and deactivate application” hiring task as the fulfiller for the “Change state to not hired and deactivate application” hiring task. As such, after the server system 218 changes the state in a profile of the applicant to not hired and deactivates the application of the applicant, the server system 218 may proceed to end the hiring process-flow at block 320.

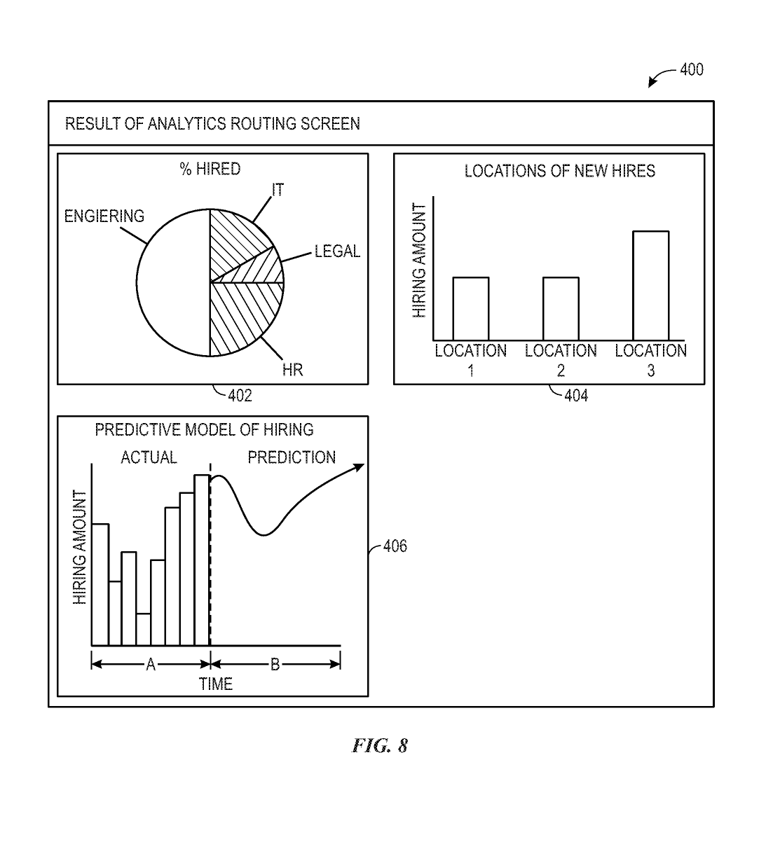

It is noted that in some embodiments, deactivation may refer to a complete removal of the applicant and the profile of the applicant from one or more databases 108. In other embodiments, deactivation of the application refers to an archiving, or storing, of a completed hiring process-flow to the profile of the applicant, where the completed hiring process-flow, the profile, or both are stored in the one or more databases 108 for accessing by members of the enterprise. The members of the enterprise may access the archived completed hiring process-flow and/or the profile of the applicant to collect data on hiring success rates, departments that hired applicants, departments that did not hire applicants, and the like. Data associated with the archived completed hiring process-flow may be accessed to perform data analytics routines, as will be described later with FIG. 8.

It should be understood that the hiring process-flow 300 is provided as merely an example of how the server system 218 may be designed to perform the various embodiments, including the method 260, described herein. However, any suitable process-flow may be implemented by the server system 218.

With the foregoing in mind, FIG. 7 and FIG. 8 are examples of an embodiment using method 260 described above. FIG. 7 is an illustration of a hiring process overview 340. The hiring process overview 340 features a visualization of data for an applicant 342, including visualizations of a name 344 of the applicant 342, a position 346 the applicant 342 applied for (e.g., the position 346 that an application event was generated by the applicant to apply for), a department 348 of the position 346, and of an employment type 350 of the position 346 (e.g., full time, part time). The hiring process overview 340 associates the applicant to an application number 352 and to a hiring process-flow 354. The application number 352 may be specific to the applicant 342 and the position 346. The server system 218 may use the application number 352 to access data stored regarding the hiring process-flow 354 and/or may use the application number 352 to reference the hiring process overview 340. In some embodiments, the server system 218 may hyperlink back to the hiring process overview 340 and/or digitally reference to the hiring process overview 340 such that a member may follow the digital reference back to the hiring process overview 340 via an input data transmitted from an input structure 208 through the application number 352.

The hiring process overview 340 may include indications of fulfillers of hiring tasks of the hiring process-flow 354. In some embodiments, hiring tasks of the hiring process-flow 354 may not be displayed in the hiring process overview 340. In these embodiments, the hiring process-flow 354 may be summarized into categories of tasks associated with hiring and on-boarding an applicant. For example, the hiring process-flow 354 in the depicted example includes two sub-processes associated with hiring and on-boarding—the first sub-process includes pre-hire tasks 356 and the second sub-process includes pre-boarding tasks 358, where the server system 218 may include pre-hire tasks 356 and the pre-boarding tasks 358 as hiring tasks. Examples of the pre-hire tasks 356 may include interviewing tasks, a background check task, a drug screening task, and the like. Examples of the pre-boarding tasks 358 may include a completing 1-9 form task, a selecting equipment task, a setup office task, a setting up payroll task, a security clearance task, a badge setup task, a setup member authentication task, and the like. A completed icon 360 may be included in the visualization of the hiring process-flow 354 if tasks associated with a category are completed. For example, the completed icon 360 indicates that the pre-hire tasks 356 of the first category are completed. A progress icon 362 may be included in the visualization of the hiring process-flow 354 if tasks associated with a category are incomplete, where the progress icon 362 may indication a percentage complete of the tasks. For example, the progress icon 362 indicates that the pre-boarding tasks 358 of the second category are 50% completed.

As described earlier, hiring tasks of the hiring process-flow 354 may be assigned one or more fulfillers that is a member of the enterprise to complete a respective hiring task. The hiring process overview 340 includes visualizations of a “Hiring Manager” fulfiller 364 and a “HR Specialist” fulfiller 366 for the hiring process-flow 354 associated with the application number 352. Additionally, the hiring process overview 340 may include a drop-down list 368 of to-do items 370 for a member accessing the hiring process overview 340.

For example, the drop-down list 368 indicates that the “Hiring Manager” fulfiller 364 has three to-do items 370 to complete for the pre-boarding tasks 358. To-do items 370 may appear in the visualization as associated with the category that the tasks belong to. For example, the “Hiring Manager” fulfiller 364 has three to-do items 370 that are associated with the pre-boarding tasks 358.

The hiring process overview 340 additionally may include a field for members of the enterprise to leave one or more case notes 372. The case notes 372 may relate to interaction notes between a member and the applicant, questions or comments that arise as working with the application or the applicant, and the like. The case notes 372 may facilitate communication between members of the enterprise for matters associated with the application.

In addition, the hiring process overview 340 may include a chat function 374 where members accessing the hiring process overview 340 that have questions regarding the applicant 342, regarding the application, a technical question relating to technology associated with the hiring process overview 340, and the like may enter the question. When the question is entered by the member, the server system 218 may connect the chat function 374 to a different member that may answer the question, may run a machine-learning (e.g., artificial intelligence) routine on previously entered questions, where the machine-learning routine may answer a question (e.g., a future question) based on past answers to questions (e.g., a past question), and so forth, to resolve the question with an answer that the server system 218 is able to predict as correct, or a suitable answer. Finally, as members of the enterprise, the server system 218, or the applicant 342, enters a question, performs one or more edits and/or changes to the hiring process overview 340 or data associated with the hiring process overview 340 (e.g., complete a hiring task, add a case note to associate with an application), a visualization of an update time 376 is changed to reflect the time that the edits, or changes, were performed.

Through the enterprise using a continuous hiring process-flow for each applicant, the server system 218 may improve performing analytics on the hiring process-flows. That is, when a continuous hiring process-flow (e.g., the hiring process-flow that follows an applicant from an application event to employee on-boarding) is used to coordinate opinions, decisions, and data associated with the hiring process, the data of one or more of the hiring process-flows may be aggregated into a database 108, a memory 206, and the like for improved access. The stored data may be used by the server system 218 for various enterprise functions, like task assignment and/or predictions of future hiring. For example, the server system 218 may perform analytics routines on the stored data (e.g., one or more hiring processes, one or more applicant profiles, one or more member profiles, and the like) through data analytics routines to analyzing data regarding hiring processes, hiring results, and/or interactions between applicants and members.

As such, FIG. 8 is a screen 400 that displays results from the data analytics routines. The server system 218, or the data analytics program 244, may transmit a visualization indicative of the screen 400 to a computing device 200 of member of the enterprise. In some embodiments, the data analytics routine may result in a chart 402 of a percentage of applicants hired by departments. The chart 402 may be represented by a percentage of applicants by location (e.g., country, state, hemisphere, continent, region). The chart 402 may alternatively show a percentage hired from a total number of applicants per department, where the percentage hired may indicate how popular a department 348 is for applicants to apply to. The screen 400 may include a chart 404 to present results related to a hiring amount (e.g., a total number, a count) of applicants by location. In addition, the screen 400 may include a chart 406 to present a predictive model of hiring for the enterprise. The chart 406 may aggregate results from the data analytics routine of the server system 218 to showcase a prediction related to hiring of the enterprise. As shown, the chart 406 may include actual (e.g., past, previous, historic) hiring data and predictions for future hiring data. It is noted that the server system 218 runs a data analytics routine at a timeframe A and displays the results at a timeframe B, so that the prediction for future hiring is based on data analytics routines performed at the timeframe A and thus the prediction for future hiring is inclusive of the predictions related to timeframe B. In other words, the server system 218 may refresh and/or perform the data analytics routine on pre-determined time intervals, in response to a trigger, in response to a change in an update time (e.g., update time 376), and the like to cause the predictions for future hiring to update. The chart 406 may include predictions on hiring for the enterprise, hiring for respective departments, hiring based on aspects of profiles of applicants (e.g., predictions based on skills listed in the profiles), and the like. The predictions may be used to predict and/or estimate an amount of new hires for future hiring.

The predictions may help the enterprise relocate, or reallocate, assets to improve planning for hiring demands. For example, a first location may have a different hiring prediction than a second location, thus HR members and IT members may be transferred from the second location to the first location to assist with hiring. In this way, the results of the data analytics routines may include a variety of results that originate from data collected from hiring practices and/or hiring processes of the enterprise. Averaging functions, performance indicating functions, thresholding functions, index scoring functions, and/or formulas building predictive indicators may all be valid applications of the data stored regarding the hiring practices and/or hiring processes of the enterprise. It is noted that in some embodiments, the visualizations for the chart 406 may be different for the presentations of the actual hiring data and the future hiring data. In other embodiments, the visualizations for the chart 406 may look similar, or the same, for the representations of the actual hiring data and the future hiring data.

With the foregoing in mind, the following is a discussion on additional embodiments associated with the enterprise usage of the hiring process-flow and skills of users. As briefly discussed earlier, the server system 218 may collect information on the applicants (e.g., skills of users derived from user interaction with the enterprise) from a centralized discussion board hosted by the enterprise that members and/or non-members may access through the internet, the server system 218, and the like. To elaborate on the centralized discussion board, upon accessing the centralized discussion board, a user accessing the centralized discussion board via a respective of the computing device 200 may interact (e.g., post questions, answer questions) with one or more additional users via the centralized discussion board. The server system 218 may associate these user interactions with a profile of the user and may analyze the user interactions, as described earlier. The server system 218 may use the results of the analysis to recommend job postings to the user based on a skill set, interest set, message rating, or other concluded competencies derived from the analysis by the server system 218. Metrics regarding the user interactions may include timeliness of a reply from the user, difficulty of a question and/or comment the user is replying to, a technical classification of a question and/or comment that the user is replying to, quality of the user response determined by a member of the enterprise, quality of the user response determined through voting by other users and/or members, and the like.

For example, a user may show a skill for scripting in a primary coding language used by the enterprise, building computing applications, and/or problem solving skills in general. The server system 218 may arrive at a conclusion regarding the skill of the user through performing one or more analysis routines on the interactions of the user with the centralized discussion board and/or through analysis of metrics collected on the interactions of the user. The server system 218 may associate the skill with a profile of the user. Thus, the profile of the user may include some or all of the interactions with the centralized discussion board in addition to any skills determined by the server system 218.

Based on the server system 218 determining skills each respective user has, the server system 218 may recommend a relevant job posting to the user (e.g., relevant based on the skills of the user). The server system 218 may use skills of a user to recommend job postings to the user match a user with particular skills to a job posting that defined the particular skills as desired skills of an applicant to the job posting. For example, a user may show a skill for building computer applications, so the server system 218 may recommend a job posting related to building such applications.

Additionally or alternatively, based on the server system 218 determining the skill to associate with the profile, the server system 218 may be instructed to automatically assign tasks to the profile based on the skill. Additionally or alternatively, the server system 218 may query databases for potential profiles to assign the task to, and using the search results, prioritize the search results based on skill relevancy (e.g., how relevant particular skills are to the task to be assigned) to the task to be assigned for a member to select which profile to actually assign the task to. The server system 218 may also query calendars, or work schedules, associated with the profile to determine which profiles have bandwidth to complete the task.

In some embodiments, the server system 218 may implement a machine-learning routine in the one or more analysis routines to analyze one or more profiles and/or analyze interactions of one or more users with the centralized discussion board. The server system 218 may implement an artificial neural network in the machine-learning routine. The neural network may be trained by a member of the enterprise, or by the server system 218 and/or an additional suitable computing device, on a training set. The training set may include positive and negative examples of user interactions with the centralized discussion board correlating to skills of the user interacting with the enterprise. Once the neural network is trained, the server system 218 may use a testing set of data that includes actual interactions of actual users with the centralized discussion board as an input into the neural network. The server system 218 may receive an indication of what skills a user has as an output from the neural network. The server system 218 may associate the skills with a profile of the user. In some embodiments, a skill determined by the server system 218 via the neural network may pass a particular certainty threshold prior to the neural network and/or the server system 218 classifying the result as a skill. This improves the hiring process-flow by providing additional evidence (e.g., in addition to a contents of a job application) that an applicant is skilled and/or qualified for the job posted in the job opening.

Additionally or alternatively, and as briefly discussed earlier, the server system 218 may track interactions of users with the centralized discussion board. The tracked interactions of the users may be associated with a skill and the server system 218 may assign each respective user of the users an aggregate point value for the skill. The aggregate point value may represent the sum of the point values of the tracked interactions associated with the respective user. The server system 218 may associate the aggregate point value to a profile of the respective user. In some embodiments, the server system 218 may automatically associate the aggregate point value to a profile of the respective user upon the respective user interacting with the centralized discussion board. In this way, a member may reference the aggregate point value and/or skills linked (e.g., associated with) to the profile of the respective user in completing hiring tasks. For example, the respective user may be an applicant to a job posting and a fulfiller may use the aggregate point value on the profile of the respective user to determine how to complete a hiring task. Thus, as described above, the aggregate point values may cause a member to understand a relative competency (e.g., competency in comparison to one or more additional applicants) and/or a participation level of an applicant, and may use this understanding in completing hiring tasks.

To aggregate the point values, the server system 218 may track points in a point aggregates table. Data may be fed into the point aggregates table and when time to determine how many points associated with a profile, the points aggregates table may be queried for the information. As such, points may be awarded for example, resolving an issue, closing a service ticket, posting content, interacting with content, other users interacting with posted content, and so on. In some embodiments, the activity may result in a single profile getting points. In other embodiments, a single activity may result in multiple profiles being awarded points. Thus, points may be used to track a user's skills in a particular area based on their activity with the centralized discussion board. For example, answering a question about network architecture and having that answer marked correct may result in points being awarded toward a user's network architecture skills. Thus, tracking skills of a user over time is useful because access to skills based on metrics and performance of the user makes a subjective practice more objective.

As previously discussed, points acquired toward skills, may communicate a user's expertise in a given area to other users. The skills point totals may be used to identify the person best suited to handle a task, resolve an issue, or answer a question. The inclusion of points and skills on a profile is useful for an enterprise not just for hiring but also for task assignment. In some embodiments, the server system 218 may reference skills of member when assigning tasks to member as part of a process-flow, and/or the server system 218 may facilitate in members accessing the skills of other members for the assignment of tasks to members. Tasks of an enterprise may include new project assignments, incident evaluations, problem/issue resolution or solving, customer compliant addressing, general debugging and/or monitoring operations, and the like. For the tasks described, it is important to assign members who have experience in the areas. Tracking the skills of members, and members' history with the enterprise, may improve the assignment of these skill-related tasks.

Furthermore, if a member decided to leave the enterprise, or if the enterprise hires a new member that the enterprise lacks skills for, transferring and/or communicating skills of a member between enterprises may be complicated. The transfers of members may leave skills uncommunicated between the enterprises. Thus, through associating skills and performance metrics to profiles of members of enterprises, the communication of skills between one or more enterprises is improved. Skills may be communicated between enterprises when server systems (e.g., server system 218) of the enterprises are communicatively coupled together through the distributed computing framework (e.g., via cloud service 104). As an example, when a member is hired from a first enterprise to work at a second enterprise, skills of the member are likely not communicated in the change. The second enterprise may be interested in skills the member accrued during tenure at the first enterprise but may not have access to performance metrics or skill related to activities of the first enterprise (e.g., a count of successful answers the member posted to the centralized discussion board of the first enterprise). Thus, the skills may be tracked through the profile of the member and transferred to the second enterprise upon the change in employment of the member.

In these cases, an enterprise may have confidential information associated with a skill of a member. The enterprise may opt to provide a stripped version, or an altered version, of the skill, or member profile, to a second enterprise. Versions of skills (e.g., altered skill, altered profile) shared between enterprises may vary through title, description, and/or other metadata of the skill. The altered version of the skill may be based on permissions (e.g., rules) between the enterprises, or agreements to exchange particular types of information but not others. For example, the member who is transferring from the first enterprise to the second enterprise, may have solved a particular number of incidents of the first enterprise. The first enterprise may not want the second enterprise to have access to certain data regarding incident information. Thus, a rule may exist such that the first enterprise may opt to provide the second enterprise with some information about the incident and may opt to not provide other information about the incident. In some embodiments, the first enterprise may opt to provide the second enterprise with general indication of question resolution, event resolution, or a may use a different phrase reducing a severity of the incident as a tactic to keep incident information secret from the second enterprise (e.g., by calling incidents “community questions”). In this way, the first enterprise and the second enterprise may exchange data concerning incidents while protecting privacy of the enterprise.

Technical effects of the disclosure include tracking an employment history of a member of an enterprise through hiring processes, employment, and through transferring to a different enterprise. The employment history may be digitally associated with a profile of the member. In some embodiments, skills may be digitally associated with the profile of the member when the skills belong to the member. If a member changes employment from a first enterprise to a second enterprise, the first enterprise and the second enterprise may share the profile of the member and, in some embodiments, the employment history of the member, as to facilitate in the transition of the member. The employment history and tracking of skills of the member improves upon technology of assigning tasks to members of an enterprise because metrics tracked over time and associated with the profile of the member may build a representative view of skills (e.g., ability) of the member that may be used in assigning tasks to the member. In some embodiments, skills of users who interact with an enterprise may be logged, tracked, and/or maintained in addition to the skills of members.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system, comprising:
a database disposed within a remote network management platform that manages a managed network, wherein the database contains licensing information that includes respective indications of license rights allocations and consumption for each of a plurality of software applications associated with the managed network; and
one or more server devices, disposed within the remote network management platform, configured to provide, to a client device associated with the managed network, a representation of a graphical user interface that displays a respective software application of the plurality of software applications, wherein the respective software application is associated with an enterprise and is configured to:
maintain profiles associated with users, wherein each of the profiles comprises one or more skills based on interactions of the users with an enterprise;
determine a skill associated with performing a function of the enterprise;
search the respective software application to identify a respective profile that comprises the skill from a plurality of profiles; and
upon identification of the respective profile, assign a process-flow to the respective profile associated with the function of the enterprise.

2. The system of claim 1, wherein the respective software application is configured to store the plurality of profiles, the plurality of tasks, and the one or more indications of skills in a same or a separate database.

3. The system of claim 1, wherein the respective software application is configured to store the plurality of profiles, the plurality of tasks, and the one or more indications of skills in one or more tables.

4. The system of claim 1, wherein the respective software application is configured to communicate with a data analytics program to do one or more of the following:
analyze hiring processes associated with the function of the enterprise;
analyze hiring results;
analyze a completion of the function of the enterprise; and
analyze interactions between the users.

5. The system of claim 4, wherein the one or more databases are configured to store a plurality of data analytics, and wherein the data analytics program further references the plurality of data analytics.

6. The system of claim 4, wherein the respective software application is configured to communicate with the data analytics program to update a data analytics indication on a graphical user interface.

7. The system of claim 1, wherein the respective software application is configured to coordinate a plurality of departments of the enterprise to complete a process-flow, wherein the process-flow comprises the function of the enterprise as a task.

8. The system of claim 7, wherein the respective software application is configured to coordinate completion of the process-flow through:
determining a status of a task of the process-flow;
if the task is complete, updating the process-flow to indicate the task is complete; and
notifying the respective profile the task is complete.

9. The system of claim 8, wherein the respective software application is configured to assign a subset of profiles of the plurality of profiles to the process-flow.

10. The system of claim 1, wherein the respective software application is configured to share at least one of the plurality of profiles, the plurality of tasks, and the one or more indications of skills with an additional software application of an additional enterprise based on at least one of the following:
licensing information;
indications of license right allocations;
directional trust levels;
bi-directional trust levels; and
enterprise permissions.

11. A system, comprising:
a database disposed within a remote network management platform that manages a managed network, wherein the database contains licensing information that includes respective indications of license rights allocations and consumption for each of a plurality of software applications associated with the managed network; and
one or more server devices, disposed within the remote network management platform, configured to provide, to a client device of a respective enterprise of a plurality of enterprises associated with the managed network, a representation of a graphical user interface that displays a respective software application for the respective enterprise of the plurality of software applications, wherein the respective software application is configured to:
maintain a function, wherein the function is associated with a departmental task of the respective enterprise;
maintain a profile of a user, wherein the profile of the user comprises one or more skills based on interactions of the user with the plurality of enterprises;
determine a skill associated with the function; and
if the profile comprises the skill associated with the function, recommend to the respective enterprise that the profile of the user be associated with the function.

12. The system of claim 11, wherein the respective software application is configured to determine the skill associated to the function by executing a machine-learning algorithm determining to associate the skill to the function based on positive examples and negative examples of past function completion.

13. The system of claim 11, wherein the respective software application is configured to:
assign the profile of the user to the function;
determine a completion status of the function; and
if the completion status indicates the function is complete, update a process-flow to indicate the completion status of the function.

14. The system of claim 11, wherein the respective software application is configured to:
determine one or more rules associated with sharing the profile of the user with an additional enterprise;
alter the profile of the user based on the one or more rules to create an altered profile; and
share the altered profile with the additional enterprise.

15. The system of claim 11, wherein the respective software application is configured to:
perform a data analytics routine on the function;
in response to results from the data analytics routine, generate a visualization; and
update a graphical user interface with the visualization.

16. The system of claim 11, wherein the respective software application is configured to:
create a process-flow including the function as one of a plurality of process-flow tasks, wherein the process-flow is configured to track a progress of the departmental function of the enterprise, wherein the departmental function of the enterprise is considered completed upon completion of process-flow tasks;
determine a completion status of a respective task of the plurality of process-flow tasks;
in response to the completion status being completed, update the process-flow to indicate the completion status of the respective subset task as complete; and
notify the user through the profile of the user that the respective task is complete.

17. The method of claim 16, comprising:
determine a second profile from the plurality of profiles to assign a second process-flow task of the plurality of process-flow tasks based at least in part on a skill associated with the second process-flow task;
assign the second process-flow task to the second profile by associating the respective process-flow task with the second profile in the database.

18. A method, comprising
maintaining a function of an respective enterprise of a plurality of enterprises;
maintaining a first profile, wherein the first profile comprises a first indication based on an interaction of a first user associated with the first profile with the plurality of enterprises;
determining a second indication associated with the function;
determining if the second indication is the first indication;
if the second indication is the first indication, associating the function with the first profile.

19. The method of claim 18, comprising,
maintaining a job posting for the respective enterprise;
receiving an application event, wherein the application event is configured to transmit in response to a second user submitting an application to the job posting;
in response to the application event, creating a second profile to associate with the second user;
creating a hiring process-flow, wherein the process-flow is configured to coordinate a completion of a plurality of additional functions of the respective enterprise and the function;
receiving a completion status from the first profile upon completion of the function; and
determining to hire the second user based on completing the hiring process-flow, wherein the completing of the hiring process-flow is based at least in part on the completion status configured to transmit from the first profile.

20. The method of claim 18:
in response to completing the function, incrementing a number of points associated with the first indication in a database, wherein the first indication represents a skill level of the first user defined through one or more metrics of the respective enterprise, and wherein the incrementing of the number of points is configured to indicate an increase in skill level of the profile of the user through performing the function;
creating a visualization indicative of the increase in skill level; and
displaying the visualization on a graphical user interface.
